(19) United States
(12) Patent Application Publication
(10) Pub. No.: US 2001/0056463 A1
(43) Pub. Date: Dec. 27, 2001

(54) Method and system for linking real world objects to digital objects

(76) Inventors: James D. Grady, Palo Altos, CA (US); Gregory L. Whittemore, San Jose, CA (US); Pratik D. Wadher, Sunnyvale, CA (US); Mark Painter, Fremont, CA (US); Melanie Starr Bleyler, San Jose, CA (US); Kurt A. Shaver, San Jose, CA (US)

Correspondence Address: BURNS DOANE SWECKER & MATHIS L L P, POST OFFICE BOX 1404, ALEXANDRIA, VA, 22313-1404, US

(21) Appl. No.: 09/812,865

(22) Filed: Mar. 21, 2001

Related U.S. Application Data
(60) Provisional application No. 60/212,728, filed on Jun. 20, 2000.

(51) Int. Cl. G06F 15/16

(52) U.S. Cl. 709/203; 709/217

(57) ABSTRACT

The present invention provides a system and method for relating physical documents to electronic documents. A code on a physical document identifying the document is identified and an electronic address, or link (e.g., a hyperlink) is provided that corresponds to the code. The electronic address identifies an electronic file that is an electronic version of the physical document. A graphical user interface (GUI) is also provided, whereby a user may organize and manipulate electronic documents or electronic addresses. A publisher and/or advertiser may publish documents associated with keyword information encoded in the form of meta information. The meta information may be encoded within the document in the form of XML tags. User statistics and other preference information is maintained in a user profile.

### FIELD OF THE INVENTION

The present invention relates to linking electronic objects with related physical objects. More specifically, the present invention relates to creating and transmitting electronic links to electronic documents that relate to physical documents, and a method and system for transmitting electronic addresses of electronic documents to a user that has requested them, and a method and system for organizing groups of electronic documents by a user.

### BACKGROUND OF THE INVENTION

In the present information age, the information available to people worldwide has increased exponentially over the past few years. While much good has resulted from this information explosion, several problems have also arisen. For example, with the current rate of increase of information available, it has become increasingly difficult to organize and assimilate pertinent information relating to one's occupation, hobbies, or other interests.

This can be seen, for example, in the field of computer science. A computer scientist interested in keeping abreast of the most recent developments in computer science is flooded with information regarding the Internet, new computer software programming languages, new programming techniques, business information of computer companies, and much more.

For busy computer scientists, the rapid expansion of knowledge in this field of employment, and the ever increasing number of publications relating to this technological field, make it extremely difficult to organize and retain articles and documents having important information that is desirable to maintain, while purging unnecessary information that is not desirable to maintain. Documents such as trade journals, commercial publications, standards publications, and the like, all of which may contain important articles, require the computer scientist to read an inordinate amount of material to keep informed of the latest developments in his field.

This problem, however, is not specific to computer scientists, but rather is common to all people, as the amount of knowledge in every field continues to increase along with the number of publications regarding areas of interest, such as one's own occupation, hobbies, or personal interests. Additionally, added complications arise when an employee desires to retain articles and other publications for future use associated with his or her employment, or when an employer desires to distribute copies of articles to employees that the employer feels are important for each employee to read and understand. Identifying and distributing important documents to employees or colleagues requires a tremendous amount of time and resources, retaining the original copy of the physical document, creating copies, creating a filing system or multiple filing systems for document retention and organization, and generally monitoring publications which may be of interest.

Therefore, it would be desirable to prevent the need for excessive, unnecessary man hours associated with monitoring, copying, duplicating, distributing, and otherwise manually handling documents that may be of interest. It is further desirable to develop a system that prevents the need for maintaining large volumes of paper document files.

### SUMMARY OF THE INVENTION

Accordingly, the present invention achieves these objectives by way of a system and method for linking real world objects, such as physical documents to digital objects, such as electronic documents, for later retrieval and manipulation. Thus, the present invention does away with the need for maintaining large paper files to store paper documents by replacing them with electronic versions. The present invention also prevents use of unnecessary resources for maintaining, copying, distributing, or otherwise handling paper documents, as it provides for all of these tasks to be accomplished electronically.

The present invention, in accordance with one embodiment of the invention, relates to a document management system and method for transmitting a code relating to a physical object contained on a physical document from a client by way of a client computer to a server to retrieve an electronic version of a physical document from the server. The electronic version of the physical document is specified by way of an electronic address (e.g., an electronic link or hyperlink) that may be transmitted via a computer network to the client from the server, and is obtained from a database accessible by a server that relates the electronic address of the electronic version of the physical document to the code transmitted by the user.

In accordance with another embodiment of the present invention, a method of managing electronic versions of physical documents is provided that obtains a code related to a physical document, finds an electronic address on an electronic form of the physical document related to the code, and transmits either the code or the electronic address to the user. The user may then retrieve the electronic version of the physical document by way of its electronic address, and may share either the code, the electronic address, or the electronic document with others. Additional functionality is also provided, such that electronic documents may be searched, sent to others, organized according to keywords, or otherwise electronically manipulated by the user.

According to another embodiment of the present invention, a system and method is provided that is capable of linking physical documents (e.g., a paper document) to one or more corresponding, virtual representations. In general, this system and method is implemented by incorporating on or into the physical document, a numerical code or an image representing a code, such as a graphical representation of numbers, a barcode, a two dimensional image, a stylized font, a trademark, a logo, and so forth. The code is read, scanned, entered, or otherwise transmitted to the server by way of a variety of techniques. Once the code information has been prepared for transmitting, it is transmitted to a server, where the electronic address of an electronic version of the physical document containing the code object is retrieved and the code, the electronic address, or the electronic document is transmitted to a user.

Information that is transmitted to the user, or the user's computer (e.g., a client computer) may be based, for example, on user profile data maintained at the computer or server, or keyword information associated with the physical document. Profile information may also be maintained as to a user's preferences, for example, regarding such things as language preferences, expected audience, and the like. This profile information includes, for example, usage statistics, such as the use and transmission of electronic documents, tracked by the present invention, and electronic mail (e-mail), address information associated with people sending, or receiving electronic addresses or related codes.

Additionally, annotations in the electronic document, which may be stored as meta information in a markup language format, are analyzed to reveal to which code they correspond. Meta information may also be used by the present invention to tailor the presentation of an electronic document to a user.

Further features and advantages of the invention are explained in greater detail hereinafter with reference to specific embodiments which are illustrated in the accompanying drawings, wherein like reference numerals are used to identify like elements.

### BRIEF DESCRIPTION OF THE DRAWINGS

FIG. 1 is a block diagram of the system of an embodiment of the present invention.

FIG. 2 is a flow diagram of the on-line storage technique used in accordance with an embodiment of the present invention.

FIG. 3 is a flow diagram of on-line document retrieval in accordance with an embodiment of the present invention.

FIG. 4 is a computer screen image of a window used to obtain a document from a document code in accordance with an embodiment of the present invention.

FIG. 5 is a computer screen image of a document retrieval screen associated with an embodiment of the present invention.

FIG. 6 is a computer screen image of a folder creation screen in accordance with an embodiment of the present invention.

FIG. 7 is a flow diagram of on-line functionality provided by an embodiment of the present invention.

FIG. 8 is a flow diagram illustrating aspects of the user interface in accordance with an embodiment of the present invention.

FIG. 9 is a computer screen image of a login screen associated with the user interface of an embodiment of the present invention.

FIG. 10 is a flow diagram of on-line interaction in accordance with an embodiment of the present invention.

FIG. 11 is a computer screen image of a user account interface associated with an embodiment of the present invention.

FIG. 12 is a computer screen image of a window providing user functionality in accordance with an embodiment of the present invention.

FIG. 13 is a computer screen image of a window providing user functionality in accordance with an embodiment of the present invention.

FIG. 14 is a computer screen image of a window by which a user may send an article to desired recipients via electronic mail (e-mail), in accordance with an embodiment of the present invention.

FIG. 15 is a computer screen image of a user account interface in accordance with an embodiment of the present invention.

FIG. 16 is a computer screen image of an electronic version of a physical document retrieved by a user in accordance with an embodiment of the present invention.

FIG. 17 is a computer screen image of a user account interface in accordance with an embodiment of the present invention.

FIG. 18 is a flow diagram of the technique associated with document code input in accordance with an embodiment of the present invention.

FIG. 19 is a flow diagram illustrating the print layout process in accordance with an embodiment of the present invention.

FIG. 20 is a flow diagram illustrating the on-line publishing process in accordance with an embodiment of the present invention.

FIG. 21 is a flow diagram illustrating the publisher advertisement layout process in accordance with an embodiment of the present invention.

FIG. 22 is a flow diagram illustrating the advertiser on-line publishing process in accordance with an embodiment of the present invention.

FIG. 23 is a flow diagram of document validation performed in accordance with an embodiment of the present invention.

### DETAILED DESCRIPTION

To facilitate an understanding of the principles and features of the present invention, it is explained hereinafter with reference to its implementation in an illustrative embodiment. In particular, the invention is described in the context of retrieving electronic addresses, in the form of uniform resource locators (URLs), of electronic versions of physical documents, transmitting these addresses to a client computer by way of a network, such as the Internet, and providing on-line functionality for retrieving, organizing, sending, sharing, and otherwise manipulating the electronic address on the electronic version of the physical document. More specifically, an exemplary embodiment of the present invention utilizes tools to create electronic versions of physical documents, which may contain embedded information, encoded using extensible mark-up language (XML), and which allows analysis of information such as keyword lists of each of the physical documents, which can be used to present the electronic document to a user according to the user's preferences. URLs or electronic documents, in accordance with this specific embodiment, are forwarded to users and presented in an interface similar to e-mail interfaces, which allows the user to manipulate the URLs of electronic documents stored in the user's account by reviewing, organizing, sharing, or sending electronic documents or their URLs.

It will be appreciated, however, that this is not the only embodiment in which the invention can be implemented. Rather, it can find utility in a variety of computer configurations, as will become apparent from an understanding of the principals that underscore the invention. For example, rather than transmitting the URL of an electronic document, a code related to the URL could be transmitted and allow a user the same functionality of manipulating the electronic document as provided by using the URL.

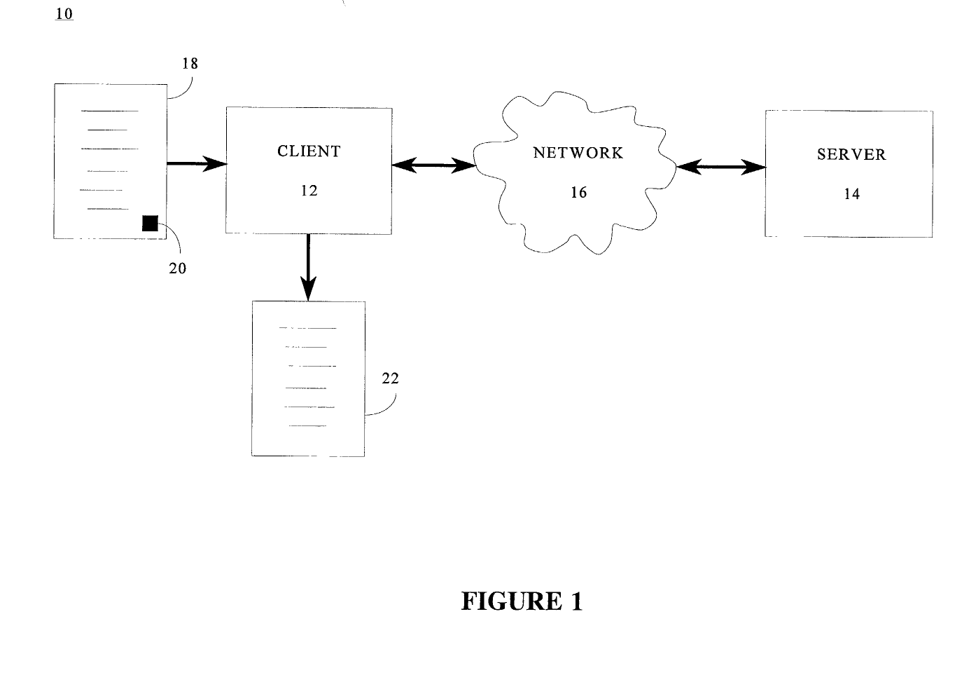

The system of the present invention, in accordance with an embodiment thereof is illustrated in FIG. 1. Referring to FIG. 1, the system 10, according to one embodiment, comprises a client computer 12 and a server 14 which are connected by way of a network 16, such as the Internet, a local area network (LAN), a wide area network (WAN), a virtual private network (VPN), wireless, or other suitable communications network. Additionally, multiple computers may be used by the server 14 to provide remote functionality to the client computer 12 by way of the network 16, and the functionality provided by the server 14 need not be limited to a single computer unit. Although only one client computer 12 is shown in the system 10, multiple client computers may be connected to the network 16 to communicate with the server 14 each of which may be configured to individually communicate with the server 14.

In FIG. 1 a physical, printed document 18, such as a magazine article, newspaper article, trade journal article, or the like, is represented. The physical document contains a physical identification object 20, in the form of a code, which serves as an identification for the physical document 18. A user, upon perusal of the physical document 18, may make a determination that the document 18 is useful and desirable to maintain in electronic format, and may enter the code 20 contained thereon into the client computer 12. This code 20 may be input into the client computer 12 by way of a variety of techniques.

For example, a user may read a legible code, and enter the code into the client computer by way of a traditional input method, such as a mouse, keyboard, or other similar input device. Also, a telephone number which allows a user to connect with the server by telephone may be granted individual access, by way of a user identification code (e.g., a PIN) entered by the user, or by way of a caller identification (caller-ID) signal on the telephone line, to provide the account of the user. The user may then dial a code associated with a desired document, and the server may provide the user with an electronic link to the electronic document whose code was dialed by the user on his or her telephone. This may be accomplished in various manners. For example, in the case of an intelligent telephone capable of connecting to the network 16, the telephone may perform the role of a client 12, as described in connection with FIG. 1. Alternatively, a telephone could connect to an interactive voice response (IVR) gateway, which could be configured to perform the role of a client 12, as described in connection with FIG. 1.

Additionally, in the case that the identification code 20 is a machine-readable code, such as a barcode, or other similarly encoded object, a user may utilize a scanner, or other similar technology to read the code. Devices such as personal digital assistants (PDAs), mobile telephones, or other portable computing devices able to scan images may also be used. In accordance with a specific embodiment of the present invention, a specialized code acquisition device, which may, for example, be shaped in the form of a pen, keyfob or other convenient form, may be used acquire the code.

It is anticipated that other identification object types may be implemented and successfully utilized within the system 10 shown in FIG. 1. For example, a legible numeric code, a stylized font, a trademark, or logo could be used to create the code 20. in addition to optical technologies, magnetic and other storage or recording media may be used to store the physical identification code 20 on the physical document 18. In such cases, appropriate devices would be required to extract the identification code information from the code 20 to input the information into the client computer 12. For example, in the case of a magnetically stored code, a device capable of reading magnetically stored information would be used.

It will be appreciated that the object identification code 20 could contain additional information other than simply identification of the information contained within the document 18. The code could, for example, contain information regarding the language of the information contained in the document, the type of information contained in the document, information regarding the expected audience of the document, and other similar information. However, those skilled in the art will appreciate that such a code would be longer and would only be suitable for automatic entry.

Software on the client computer 12 may be configured to allow instructions regarding the eventual disposition of the code and any electronic addresses or electronic documents related thereto to be saved on the client computer 12 for future implementation. This is particularly useful for codes entered at the client computer 12 while it is disconnected from the network 16 (i.e., while it is off-line). The code 20 information, along with any instructions relating to it (e.g., instructions entered by a user), is maintained at the client computer 12 until it is again connected to the network 16 (i.e., while it is on-line), at which time the code 20 and any instructions relating to it are transmitted, by way of the network 16, to the server 14 for further processing.

Once the information has been entered into the client computer 12, whether manually by a user, or by way of some other data entry or scanning technology, the client computer 12, which retains information regarding the user and information obtained from the object identification code 20, transmits the code via the network 16 to the server computer 14. The code 20 may be transmitted with instructions or other information required by the server, which may vary according to various embodiments of the present invention.

Once the code 20 is received by the server computer 14, it may forward the code 20 to other users' accounts or e-mail addresses according to instructions received from the client computer 12. The server 14 may also perform other operations (e.g., serving, sharing, sending, etc.) without retrieving the electronic document or electronic address.

The server also may utilize a mapping function, which relates the code to an electronic document's electronic address to identify appropriate digital information that corresponds to the information contained within the physical document 18 or an electronic address corresponding to the appropriate digital information, or electronic document. Once the server 14 has determined the electronic address, it transmits the address to the client computer 12, for the benefit of the user, by way of the network 16. The user then may view, send, share, save, or otherwise manipulate the electronic document 22 via the client computer 12 using software contained thereon. This software may include, for example, such software as Web browsing software, networking software, or other document handling software having the capability of sharing documents over the network 16.

Information in addition to the information contained in the physical document 18 may be accessed by way of the same electronic address corresponding to the code 20, which is sent to the user from the server 14. The code 20 is maintained by the system 10 as a proxy, or pointer, to the electronic document 22. In addition to the electronic version of the physical document, information of potential interest to the user may be linked to the electronic address. For example, information such as advertising information, related news headings, related articles, and other information may be accessed by the electronic address and represented along with the electronic document 22 accessed on the client computer 12. The electronic document may be presented in a variety of formats suitable for various uses, including but not limited to hypertext markup language (HTML) documents, text documents, and the like.

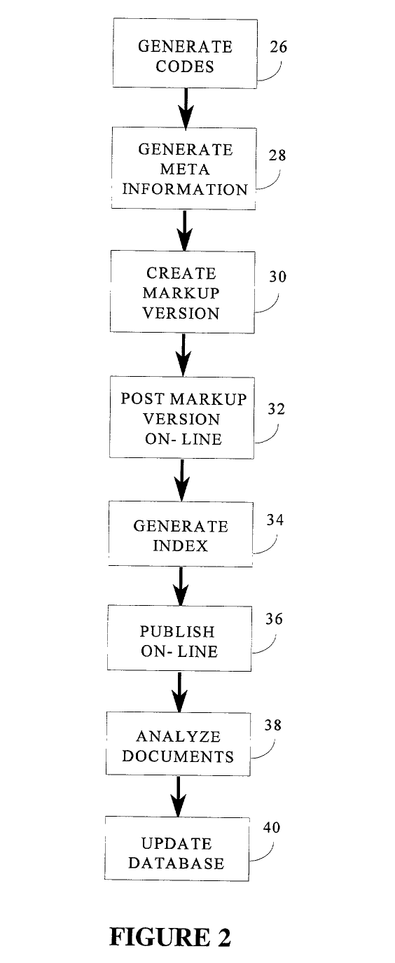

FIG. 2 is a flow diagram of the on-line storage process 24 in accordance with an embodiment of the present invention. Before a server can transmit an electronic address, or link, to an electronic document, the original physical document must be stored in an electronic format to create an electronic document. The flow diagram shown in FIG. 2 illustrates how this is accomplished, in accordance with an embodiment of the present invention.

Referring to FIG. 2, information contained in a physical document may be acquired by way of scanning a physical document, or directly from a content publisher and/or advertiser. If the document is acquired directly from a publisher and/or an advertiser, it is provided at the print stage of publication, when the document has been prepared and formatted for printing. At this stage, software may be employed to perform several important operations. These same operations may also be performed upon acquiring a scanned version of a physical document. Software used to accomplish the technique 24 shown in FIG. 2 may operate independently, or may operate as an extension of the publisher's and/or advertiser's desktop publishing software. For example, if the publisher and/or advertiser is utilizing Quark desktop publishing software available from Quark, Inc. of Denver, Colo., the software may be fully integrated within such a desktop publishing package and provide additional commands, which can be displayed in pull-down menus. These commands may be provided for invoking operations such as code generation and meta information generation.

The first of these operations is generating a publishing code 26 for each article, editorial, advertisement, or other piece of information contained in the physical document. By this operation, a unique publication code is assigned to each publication, so that the code can be published as part of the printed document or hard copy version of the publication, such as the physical document 18 shown in FIG. 1. The code generation operation also causes the unique publication code to be stored in a database that can be accessed by a server, such as the server 14 shown in FIG. 1. This database may be accessed to service user queries in retrieving documents, and to map codes to electronic addresses of electronic documents.

Another important operation performed by the software includes generating “meta” information 28, or information that describes electronic data, associated with the information contained in the physical document. The meta information generated supplements meta data provided by the publishers, such as keywords. This generated meta information may comprise, for example, additional keywords, the name of the magazine or journal, the title of the publication, the name of the authors, e-mail addresses of the authors or other contact information, URLs associated with ancillary information related to the document, natural language of the publication, and any other information which is usefully stored as meta information and to aid users in obtaining desired documents in electronic form. The meta information may be automatically generated, or manually created, and is ultimately embedded in an on-line version of the publication, in each case where an on-line version is being created. For example, if an on-line version of the electronic document 22 is to be displayed via the World Wide Web (WWW), then the meta information generated at step 28 may be embedded as markup language fragments (e.g., XML fragments) contained within the hypertext mark-up language (HTML) code of each associated web page. Additionally, generated meta information may be stored in a database to aid categorization and retrieval of desired electronic documents.

Markup language code is created in step 30, which may be XML code in accordance with an embodiment of the present invention, within which the meta information generated in step 28 is contained. This XML code containing meta information is then embedded into an on-line version, or web page in step 32 containing the electronic version of the physical document 18. Subsequently, an index is generated in step 34 as the software indexes, or creates a list, of all of the publications associated with the information contained in the physical document. This information may be, for example, information regarding each article contained in a magazine issue that may have been assigned a publication code and may have related meta information, or other such information pertinent to the document. By way of the index generated in step 34, a user may be presented with an index which preserves the structure of the physical document being indexed, and which identifies a larger unit of publication than the smaller units contained therein (i.e., the electronic documents).

Once the index has been generated in step 34, the index is published on-line in step 36 to a web site or another on-line, network-accessible location. In accordance with a preferred embodiment of the present invention, the on-line location of the index (i.e., the URL of the index) is provided to the server 14, which uses the index to locate and analyze 38 all documents published contained therein (e.g., such as all articles in a particular magazine issue). Upon receipt of the index, or its electronic address, the software at the master Web site parses the index, thereby separately identifying URLs associated with each publication in the indexed list. Additionally, the software of the hosting master Web site, which may reside on the server 14 extracts the meta information associated with each publication, and the publication code. This meta information is then used for determining the proper organization of each publication, within pre-determined groups, and to determine additional information regarding publication, such as natural language, potential audience, and so forth.

This on-line publication of the index may occur as each publisher having an individual account may optionally provide either a URL associated with the index or the document itself, along with each document referenced therein. In an embodiment wherein the publishing software is an extension of an existing desktop publication package, a publish option may be presented to a user within the desktop publishing software, which allows the user the option of electronically publishing and providing all URLs associated with documents referenced in the index. Alternatively, such software functionality may be provided by a master web site administered by the server 14, thereby allowing a user remote computing capability.

In accordance with an embodiment of the present invention designed to allow users to save web articles easily with all their content, the present invention may allow entire electronic documents to be stored in a network location accessible to the server. Thus, any graphs or pictures in a physical document being stored in electronic format is saved along with text so that when a user clicks on a link to the electronic document, the entire article is displayed. This information may also be stored locally so that electronic documents can be viewed on the client computer 12, even when it is disconnected from the network 16 (i.e., when it is off-line). Alternatively, this information may be stored on the server 14.

Once the index has been published on-line in step 36, the documents listed therein are analyzed in step 38. Multiple analyses may be performed on the document to extract desired information regarding the document. In accordance with an embodiment of the present invention, the software located at the master Web site employs a keyword extraction and/or an analysis engine to identify a list of keywords associated with the subject matter of each publication contained in the index. The keyword list developed is then compared to the list of keywords provided by the publisher as meta information, and newly identified keywords may be appended to this keyword list.

Once the document has been analyzed, the master database, which contains information relating to each of the electronic addresses of electronic documents corresponding to physical documents, is updated. This is accomplished in step 40, as the database is updated with publication information.

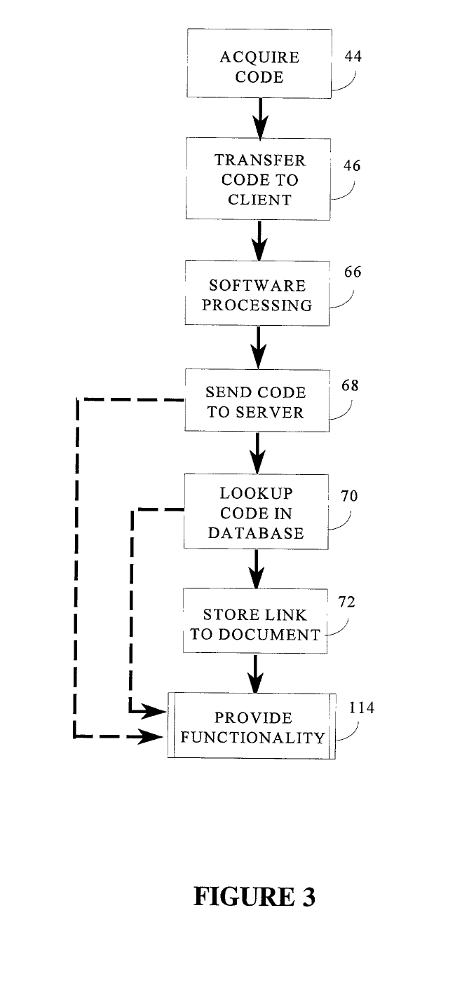

A user may access the documents, the electronic addresses of which are maintained in the database, by way of software contained on a client computer 12. Documents may also be accessed in a distributed computing environment using a remote computer to access addresses in the database and facilitate retrieval of the documents referenced by the electronic addresses. This is accomplished, as illustrated by the flow diagram shown in FIG. 3, by an on-line document retrieval technique 42.

Using the on-line document retrieval technique 42, a document code is acquired in step 44, such as the identification code 20 associated with the physical document 18 of FIG. 1. According to an embodiment of the present invention, this document code may be acquired by way of a scanning device. For example, if the code is in the form of a standard barcode or image code, a barcode or image code reader and storage device may be used to capture and temporarily the code information. Alternatively, code information that is in a legible form may be manually read from the publication by a user. Moreover, any device capable of scanning a code may be used for this purpose. For example, PDAs, mobile telephones, and other portable electronic devices may be used to accomplish this task. If other forms of recordable media are used to store the identification code, then it is anticipated that other readers used to read data from such storage media will be used to acquire the document code in step 44.

Once the document code has been acquired, it is then transferred to the client computer 46, such as the client computer 12 shown in FIG. 1. In accordance with an embodiment of the present invention, wherein the document code is acquired in step 44 by way of a portable electronic device, the step of transferring the code to client computer may be accomplished by way of an electronic data interchange connection.

For example, if a PDA is used to scan a document code, then when the PDA is synchronized with the client computer, the document code information may also be transferred to the client computer for further processing. This type of synchronization may take place even while the client computer 12 is not connected to a network. The codes synchronized with the client computer while not connected a network (i.e., while the client computer is off-line) will be saved for later transmittal via the network when the client computer is again reconnected to the network (i.e., when it is again on-line).

Those skilled in the art will recognize that electronic documents accessed by way of the present invention may be organized into categories, directories, folders, and the like, all of which may be used to recreate the user's account configuration while off-line, or disconnected from the network, without departing from the spirit of the present invention. In such a scenario, once the client computer reconnects to the network, codes and files will be uploaded immediately and automatically to the server 14 via the network 16, maintaining the account configuration viewed by the user while off-line. On the other hand, if a user is connected to the network when trying to synchronize a device, codes, and files will be automatically uploaded into user's account. In accordance with an embodiment of the present invention, a status bar may be provided to allow a user to visually monitor progress of any transfers, uploads, and so forth.

The document code may also be transferred to the client computer manually (e.g., by way of a keyboard or other input device) in the case that the document code is obtained by manually reading a legible document code from the physical document. It is also anticipated, that transferring the document code to the client computer may be accomplished by way of any electronic device that can transfer data, or which can input data, to a client computer. Additionally, the document code information may be transferred, if acquired remotely, by way of any wired or wireless communication device which is connected to a network on which the client computer resides, and which is capable of communicating via such a network.

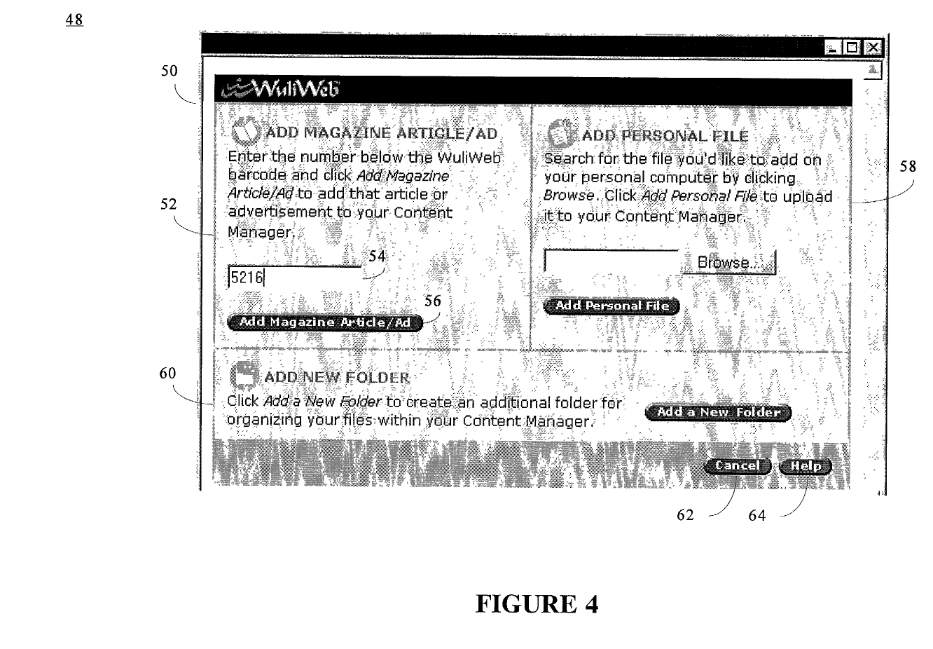

The computer screen image 48 shown in FIG. 4 shows a document request window whereby a user may optionally enter a publication code manually in a client computer, which corresponds to a physical document, as in step 46 shown in FIG. 3. In the computer screen image 48, a window 50 is provided by an Internet Web browser wherein various functions may be performed in accordance with an embodiment of the present invention. One of the functions that may be performed is to retrieve a link to an electronic version of a document by way of the identification code contained on the physical document. This functionality is provided in frame 52, entitled “ADD MAGAZINE ARTICLE/AD”. In this frame, a code which corresponds to the document identification code 20 shown in FIG. 1, is entered in the data entry field 54. In this case the code 20 consists of four numeric digits, “5216.” Once this code has been entered, in this case by way of manual entry, a user may point and click the “Add Magazine Article/Ad” button 56 located directly below the data entry field to retrieve the electronic address of the electronic version of a publication associated with the code 20.

Other functions may also be provided by way of the window 50. For example, a personal file may be added by way of the data entry field in the “ADD PERSONAL FILE” frame 58, or a new folder may be added by way of the “Add NEW FOLDER” frame 60 at the bottom of the window 50. Additionally, for the convenience of the user, a “Cancel” button 62 and a “Help” button 64 are provided. These buttons 62, 64 allow a user to cancel any transactions, thereby closing the window 50, or to request help regarding the functions of the window 50, respectively.

Once the code has been transferred to the client computer, software processes the document code in step 66. According to an embodiment of the present invention, this processing software is located on the client computer; however, such software may reside on a network gateway or, in a distributed computing system, on a remote host computer. The client software reads and/or translates the publication code, or document code, maintains a user's identification and password information, and may, optionally, maintain an address book to support sending electronic addresses to other recipients, or sharing electronic addresses with other users.

The present invention may, in accordance with one embodiment thereof, provide an address book that maintains a list of recipients, where each recipient is uniquely identified. This unique identification may be according to e-mail addresses, or other identifiers, which may be cross-referenced to additional identifiers such as telephone numbers, names, and so forth. Once the client software reads the publication code, the client software may prompt the user to enter, identify, or select other recipients of the document associated with the code, if there be any such desired recipients. It will be appreciated by those skilled in the art, that client software could prompt the user to send to or share a document with certain users based upon predetermined preferences of those users or the user being prompted.

The code information is then transmitted to the server in step 68 along with such additional information as a publication code, a user identification and password, a recipient list, or any other pertinent information. Upon receipt of the information transmitted in step 68, the server accesses a database to look up the code to retrieve the electronic address associated with the electronic publication identified by the transmitted publication code, and other user preference and publication information. The database may reside on the server itself, or may be connected to the server by way of a direct connection, or network connection, and may be a part of a multi-tier architecture or other standard network architecture.

The electronic address or link, which in accordance with an embodiment of the present invention, may comprise a URL, is stored in a database accessible by the server in a user account in step 32. In accordance with an embodiment of the present invention, each user may be allocated a specific amount of storage space which may vary from user to user according to a variety of parameters. Some such parameters may include, for example, account usage, account types, subscription costs, or other parameters. This amount of storage space provided to a user may allow for essentially an unlimited number of electronic addresses to be saved, while only a limited number of electronic documents may be saved depending upon system storage constraints. A user quota could be determined and indications relating to the percentage of the quota used and warnings regarding usage approaching quota limits could be provided to the user. For example, in accordance with one embodiment of the present invention, a user may be allowed 20 MB of storage space on the server 14 or a control storage device accessible by the server.

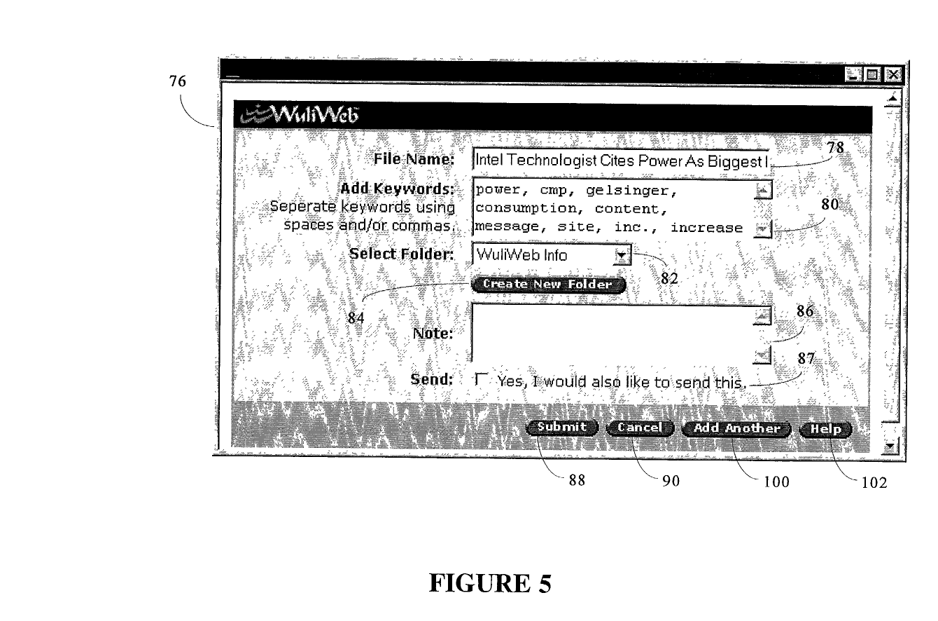

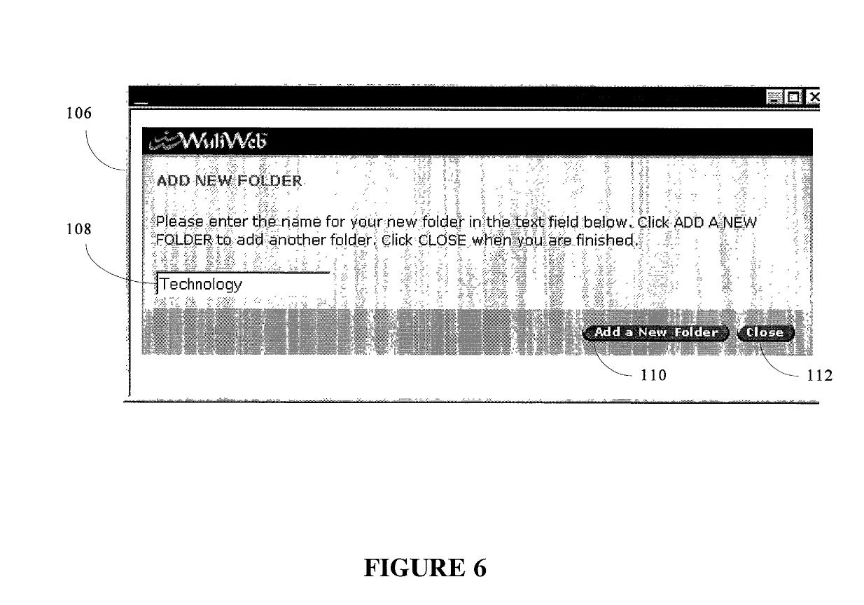

Information stored in a user account, in accordance with an embodiment of the present invention, may be presented to the user in the form of an interface similar to an e-mail interface. In such an interface, a user may be presented with electronic addresses stored in an “In box”. In such an interface, a user may organize codes, electronic addresses, or publications into folders or directories, created by a user, according to the user's preferences. Electronic addresses or codes of publications may also be organized within the user's personal account using keywords, meta information, other information relating to the publication or their content. In accordance with an embodiment of the present invention, when an electronic address or document is saved into a user's account, it will be presented in a user In box along with an “accept” and “reject” button or hyperlink to allow a user to retain or discard each item. The manner by which electronic addresses are saved to a user account is further illustrated by the computer screen images shown in FIGS. 5 and 6.

In FIG. 5, a computer screen image 74 is shown, wherein a window 76 is provided upon a code 20 associated with a physical document being transferred to a client computer, such as by a user entering a code to retrieve an electronic address of an electronic version of the physical document. This window 76 is presented to a user upon selecting the “Add Magazine Article/Ad” button 56, shown in FIG. 4. In the window 76 illustrated in FIG. 5, the title of the document is illustrated in the “File Name” field 78, and multiple keywords are provided in the keyword list 80, which have been provided by the publisher via meta data and/or from analysis of the text in the document. The user is provided with an opportunity to add additional keywords which the user deems important or necessary.

On the basis of these keywords, and/or other metrics associated with the user or document, a folder of the user's account is preselected in the “Select Folder” field 82 in which the document may be stored. A user may select a different folder in which to store the electronic address of the document, or may add a new folder (by way of the “Add a New Folder” button 84), in which this document is to be stored. FIG. 6 illustrates a window 106 presented to a user upon selecting the “Add a New Folder” button 84, whereby a user may add a new folder. Software may determine, by way of keywords and/or other information, which is the most appropriate existing folder, and place such a folder in the folder field 82 as the default selection for the current document. Additionally, a note field 86 is provided, whereby a user may add notes to the current document. A check box field 87 is also provided whereby a user may indicate that the user wishes to send the document to others (e.g., via e-mail). Additional buttons 88, 90, 100 and 102 are provided for the convenience of the user, whereby the user may either submit (i.e., store) the retrieved document to the selected folder indicated in field 82, discard the retrieved document, add another document (i.e., retrieve another electronic address of an electronic publication), or request help, respectively.

If the user selects the “Add a New Folder” button 84 shown in the window 76, the user is then presented with the window 106 shown in screen shown in the computer image 104 of FIG. 6. In the window 106 shown in FIG. 6, a user may create new folders by entering the name of a desired new folder in the data entry field 108, and clicking on the “Add a New Folder” button 110. Additionally, a user may cancel the new folder addition by clicking on the “Close” button 112, whereupon the window 106 closes and no new folder is added.

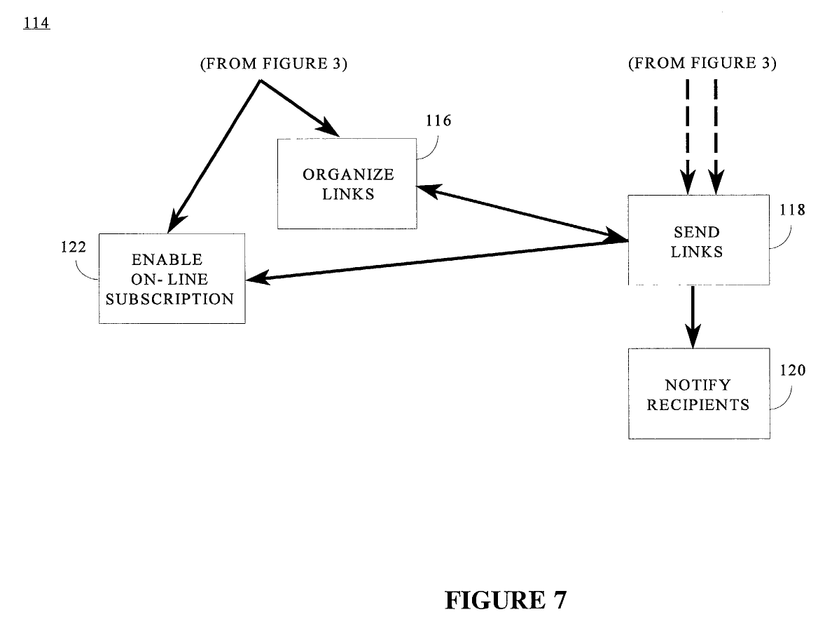

Once the link, or electronic address, to the electronic publication is stored in the user's account at step 72, user functionality is provided by subroutine 114. The functionality provided by subroutine 114 may be directly accessed, in accordance with one embodiment of the present invention, from step 70 if, for example, a desired recipient is indicated at the time that an electronic address is retrieved from a database in step 70, as shown by the broken line between step 70 and subroutine 114 in FIG. 3. Likewise, the functionality provided by subroutine 114 may be directly accessed from step 68, in accordance with an alternative embodiment of the present invention, if, for example, a desired recipient is indicated at the time the code is sent to the server in step 68, as indicated by the broken line between step 68 and subroutine 114. The details of the functionality provided by the subroutine 114 in FIG. 3, are illustrated in the flow diagram shown in FIG. 7.

In FIG. 7, the subroutine 114 of the user functionality that is provided by way of the present invention is illustrated in the form of a flow diagram. Once a link, or electronic address, to a document has been stored in step 72 of FIG. 3, user functionality is provided by way of the present invention. For example, a user can organize links (or alternatively codes) corresponding to various documents into folders, or directories, as shown in step 116. Additionally, in step 118, a user may send codes relating to electronic addresses of electronic versions of the physical documents, or the electronic addresses themselves, to multiple recipients via e-mail. In addition, as shown in step 120, the server software can send an e-mail message to each recipient of a link to whom links are sent in step 118, informing each recipient that a link has been forwarded to him or her.

In accordance with a specific embodiment of the present invention, notification e-mail messages forwarded from the server, or host website, to recipients in step 120 may be customized or tailored according to the meta information associated with the publication, or the subject matter of the publication, to which the link being forwarded relates. One example of this customization includes forwarding a subscription link with each e-mail message. Thus, by way of such customized e-mail messages, either the user or the recipients of the electronic addresses may be allowed to subscribe to a magazine or journal on-line, as shown in step 122, for example.

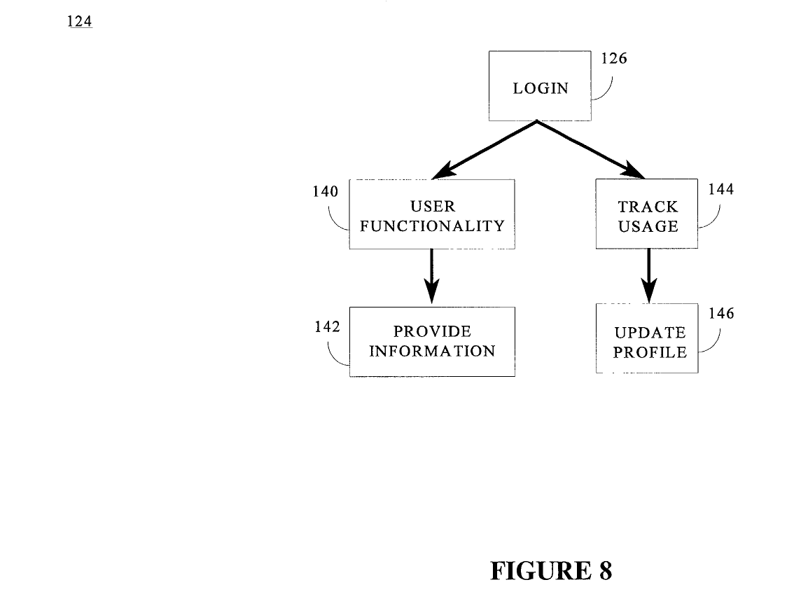

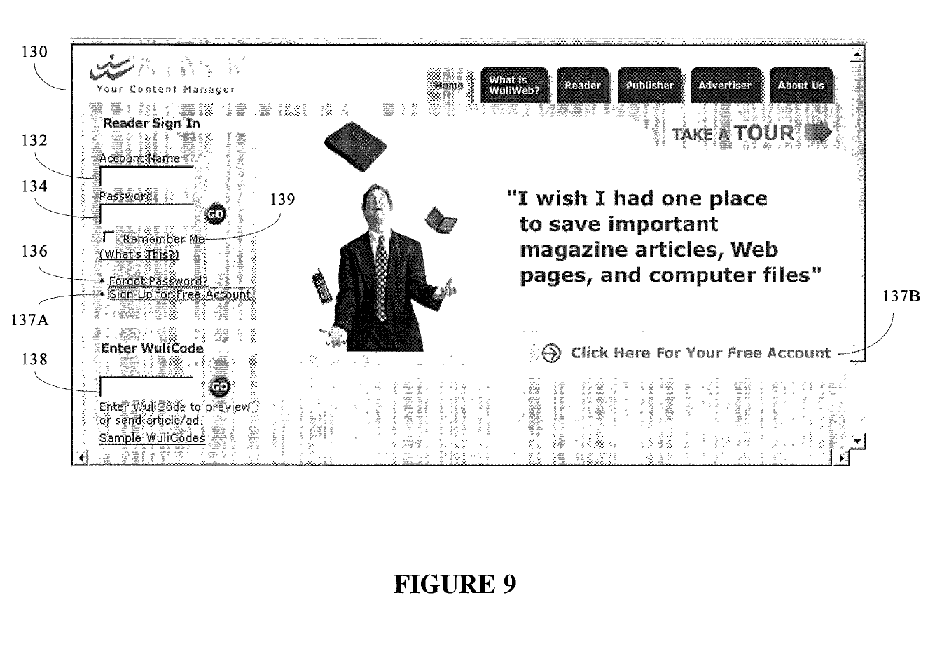

In FIG. 8, a flow diagram illustrating the user interface 124 of the client software is illustrated. Referring to FIG. 8, a user can log-in 126 to his or her account at the master Web site via any wired or wireless Internet capable device. It is also anticipated, that if the server 14 shown in FIG. 1 is located on a network other than the Internet that the logon procedure may be conducted on any device capable of communication on that network. In accordance with an embodiment of the present invention, the user may navigate to a pre-determined Web site using an Internet browser on the client computer 12, and provide a user identification and password. FIG. 9 shows an exemplary log-in screen, whereby a user may log-in to access the user's account.

In FIG. 9, a computer screen image 128 of a user log-in screen is shown. This user login screen is presented within a Web browser window 130. Within the Web browser window 130 is provided a user identification data entry field 132, wherein a user may enter the user identification, and a password data entry field 134, wherein a user may enter his or her password. A link 136 is provided for registered users who have forgotten their passwords, which indicates to the server that account information should be sent to the e-mail address associated with the user's account. Links 137A, 137B are provided for users to sign-up and obtain a user identification and password. Additionally, for the convenience of users who either do not have an account or do not wish to login, is presented a code data entry field 138, wherein a user may enter a code associated with a particular document to retrieve a preview of the electronic version of the document. A check box field 139 is provided for a user to select, allowing the server to remember the user by way of a “cookie” saved on the client computer 12, or by some other similar technique. Additionally, other buttons and links are provided, whereby a user may access various functions of the login screen within the window 130. It is by way of the login window 130, that a user logs into the system in step 126 of FIG. 8.

A user sign-up link 136 is provided for new users to sign up for a new account. It is anticipated that new users will arrive at the site displayed in the window 130 because of advertising, word-of-mouth publicity or e-mail notification messages sent to document recipients that contain information regarding the Web site hosting company and/or a link to the hosting companies Web site. Additional links to the site displayed in windows 130 may be provided by a publisher's Web site or an affiliated association's Web site. Software may be provided to track how the user arrived at the sign-up screen and may store that information as part of a user profile. The main sign-up screen, accessed by way of the sign-up link 136, may ask for information from the user, such as name, e-mail address, gender, zip code, occupation, industry, time zone, information regarding how the user was referred, and information regarding general user preferences. Also, a user may be asked to indicate whether he or she wishes to receive advertising materials or promotional information.

Once a user has logged into the system, the user may perform a variety of operations , indicated as user functionality in step 140. For example, one user functionality operation that a user may perform when logged-in is to view any publication for which a link, electronic address, or code has been stored in that user's account. A user may also share any publication for which that user has a link.

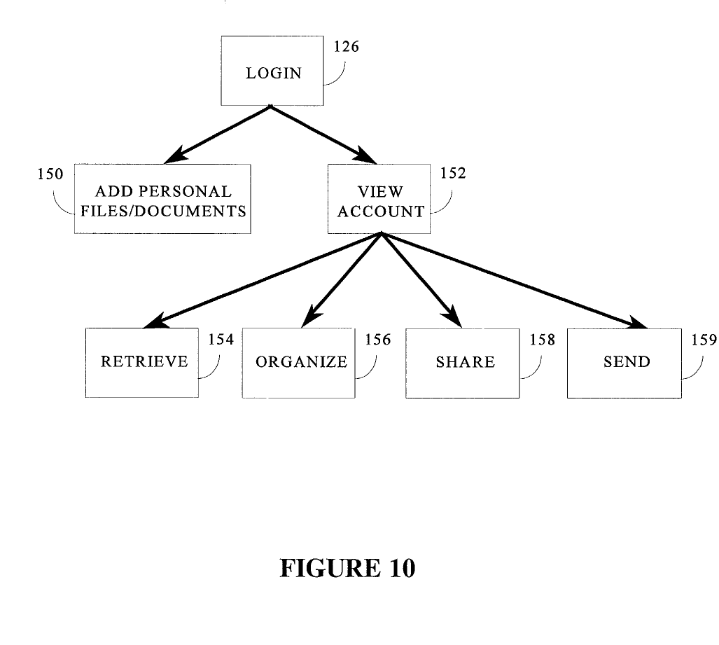

According to one embodiment of the present invention, a user can establish shared folders, or folders that may be accessed by other designated users, which allow multiple users to access the same group of codes relating to or electronic addresses of publications. The user may also search any of the documents referenced by electronic addresses in the user's account. Searching may be performed on the basis of keywords, meta information, publication name, date, author's name, and so forth. Additionally, a user can organize his or her account by creating folders, or directories, moving electronic addresses and/or documents associated with the electronic addresses into or between various folders and/or directories. A user may also upload personal documents or links to personal documents into the user's account. This allows a user to remote access personal documents, such as word processing documents, HTML documents, graphics documents, or other such files. Some functionality provided in step 140 is discussed in greater detail with reference to FIG. 10.

Additional information may be provided to a user, as shown in step 142, which may be obtained from meta information associated with each publication. Such additional information may include, for example, locations where a user may obtain more detailed information about subject matter described in the corresponding publication, such as information regarding purchasing a particular product or service or subscription information. Various other types of information may be provided to a user from the meta information maintained at the Web site, as will be appreciated by those skilled in the art.

When a user logs-in 126, the server 14 tracks the usage of the user while he or she is logged into the system, as shown in step 144. Various metrics may be tracked. According to an embodiment of the present invention, the metrics tracked by the present invention may be limited to numerical statistics to reduce the amount of storage and processing necessary to maintain such metrics. For example, the present invention may monitor information comprising, the last time the account was accessed, the number of times a document was viewed, the number of times a document was sent, the number of times a link for more information regarding a document was followed, the number of times a document was shared, the number of times a user adds a document, and so forth. This information can then be analyzed to extract useful data for publishers and advertisers.

Those skilled in the art will appreciate that other information may also be tracked, such as, the type and extent of use by each user, the types of documents reviewed by each user, and other such parameters, which may be useful to publishers and advertisers, for example.

The user profile is updated 146 based upon the tracking performed in step 144. Some information maintained in the profile information updated in step 146 may include, for example, an identification number, reader intent (e.g. pleasure, technical, research, etc.), document type (e.g. article, advertisement, document, etc.), natural language, subject matter, and so forth.

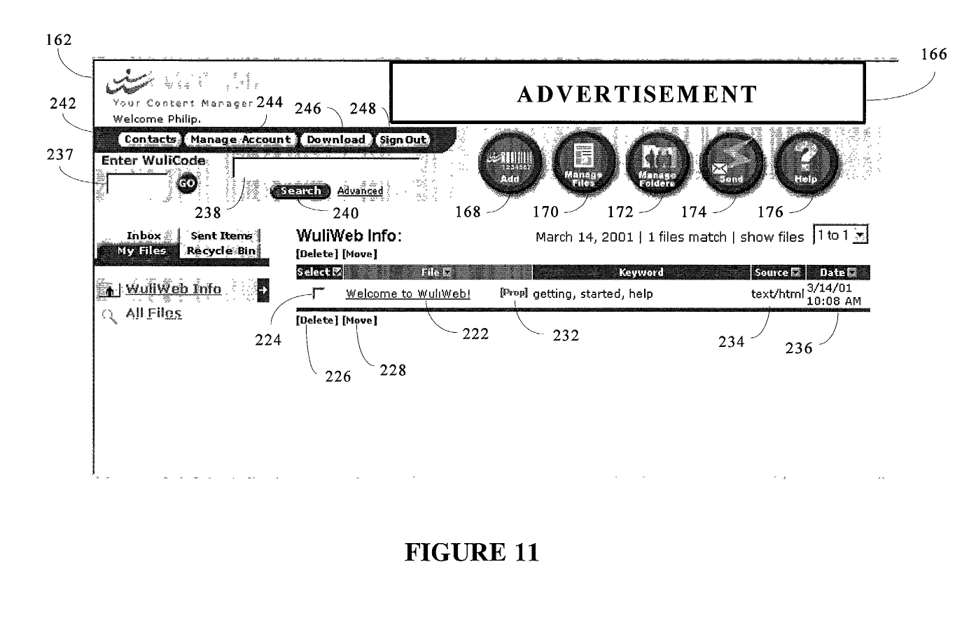

In FIG. 10, the user's on-line interaction 148, in accordance with an embodiment of the present invention, is illustrated in the form of a flow diagram. In FIG. 10, a user logs-in to the site 126, as described in connection with FIG. 8, and is provided with a variety of user functionality 140. One example previously discussed is that a user may, as shown in step 150, add personal files and/or documents to the user account. Additionally, a user may view the user account as illustrated in step 152. While viewing the user account, a user may retrieve documents 154, organize documents or folders 156, share documents and/or folders 158, and/or send documents, links, and/or codes relating to electronic documents relating to one or many recipients. Each function provided in FIG. 10 is discussed in greater detail below with reference to FIGS. 11-17.

In FIG. 11, a computer screen image 160 shown, wherein the web browser window 162 is shown displaying a user's account upon log-in. An advertisement 166 is shown, whereby advertisers may target specific users according to the user profiles discussed in connection with FIG. 8. Various buttons 168, 170, 172, 174, 176 are presented for the convenience of the user.

By way of the “Add” button 168, a user may add electronic links to electronic versions of documents by entering codes associated with the physical document, as by window 50 shown in FIG. 4, for example. A user may also add personal electronic documents to be stored in the user's account by way of the “Add” button 168.

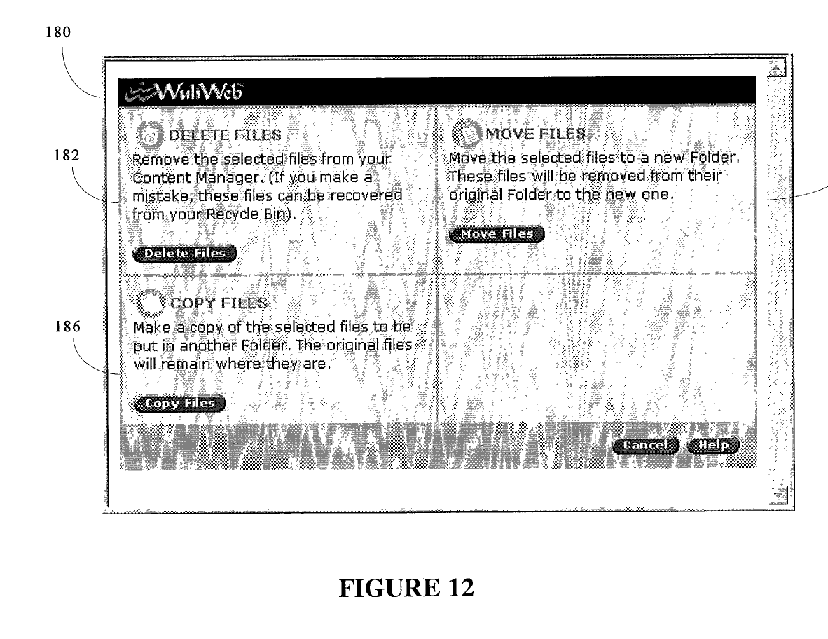

By way of the “Manage Files” button 170, a user may manage the files, and/or electronic addresses contained within his or her account. This may be accomplished by way of the computer screen image 178 shown in FIG. 12. Referring to FIG. 12, the window 180 is presented to a user upon selecting the “Manage Files” button 170, shown in FIG. 11, and provides frames 182, 184, 186, whereby a user may delete files, move files, or copy files, respectively, corresponding to the organizing step 156 shown in FIG. 10.

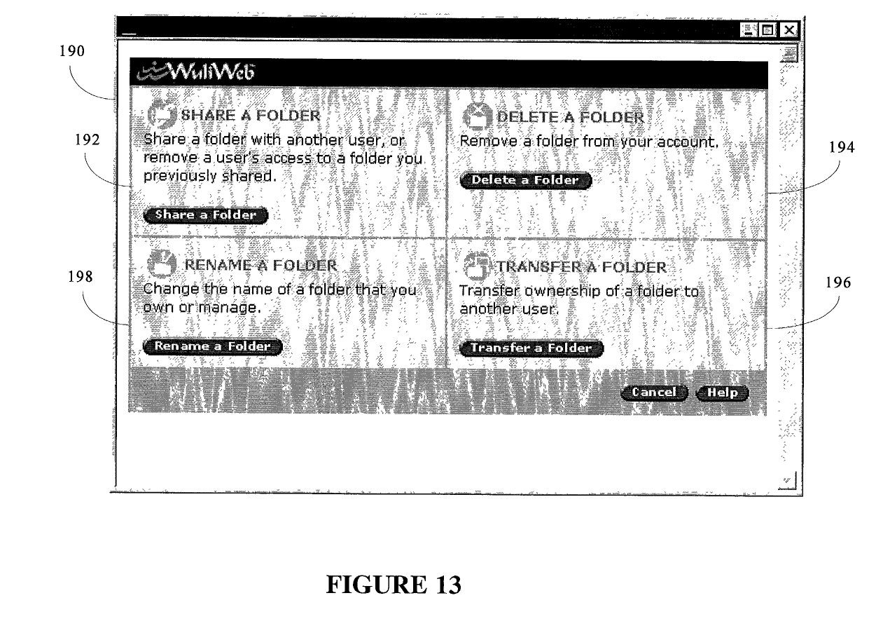

By way of “Manage Folders” button 172 shown in FIG. 11, a user may create and/or reorganize folders or directories within which documents and electronic addresses of documents may be stored and organized. This may be accomplished by way of the computer screen image 188 of FIG. 13, which contains a window 190 that provides multiple functions for a user. Referring to FIG. 13, the window 190 is presented to a user upon selecting the “Manage Folders” button 172 shown in FIG. 11, and provides functions that allow a user to share a folder. For example a user may manipulate folders as shown in the “SHARE A FOLDER” frame 192, which corresponds to step 158 of FIG. 10, delete a folder as shown in the “DELETE A FOLDER” frame 194, transfer a folder as shown in the “TRANSFER A FOLDER” frame 196, or rename a folder as shown in the “RENAME A FOLDER” frame 198. The functionality provided by the window 190 shown in FIG. 13 corresponds to the organization step 156 of FIG. 10.

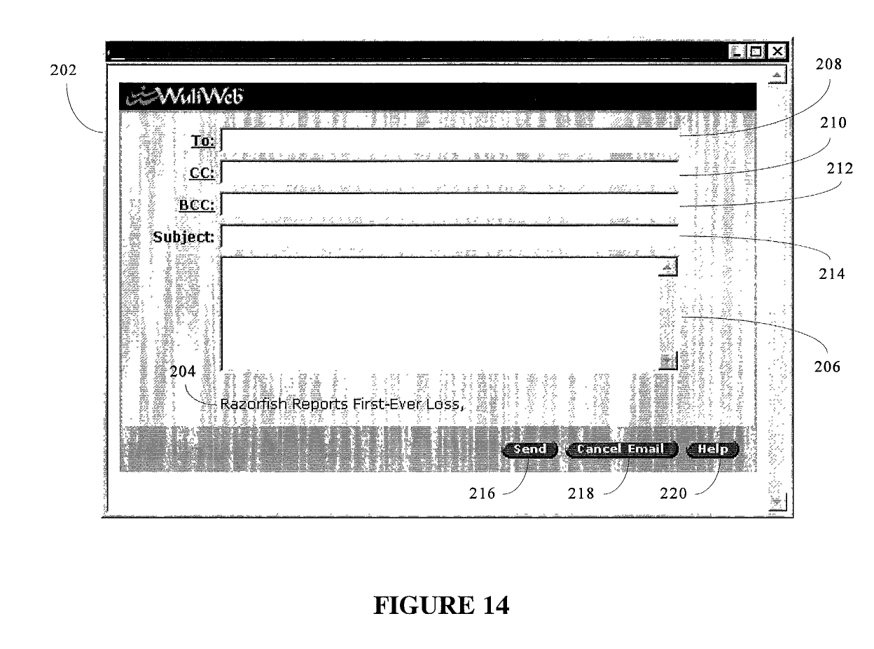

By way of the “Send” button 174 shown in FIG. 11, a user may forward any document for which he or she has a code or an electronic address, or which he or she has stored in the user account. A user may send a document code or electronic address, or an electronic document itself by way of the computer screen image 200 illustrated in FIG. 14, wherein a window 202 is presented by which a user may enter desired recipients of a particular electronic document, or its code or electronic address. Referring to FIG. 14, the send window 202 is presented to a user upon selecting the “Send” button 174 shown in FIG. 11. In the send window 202, the title of the document 204 to be forwarded to recipients is shown below the message field 206. An address field 208, wherein recipients' e-mail addresses may be entered, a copy field 210, a blind copy field 212, and a subject field 214 are all provided. Buttons 216, 218, 220 are provided for the convenience of a user in sending, canceling, or obtaining help regarding the message, respectively.

When a document, code, or electronic address is sent to a user or group of users by way of the window 202 shown in FIG. 14, the system of the present invention, according to one embodiment thereof, stores information regarding each recipient according to a unique identifier associated with each recipient. This unique identifier may be an e-mail address or other suitable identifier. Each item sent to each recipient is stored according to the recipient's corresponding unique identifier.

When a recipient then decides to sign-up for an account within the system of the present invention, then the recipient is granted access to each of the items previously sent to him or her. This may be accomplished by storing each recipient's unique identifier, and comparing it with each new user that signs-up for a new account. Thus, if a recipient's e-mail address is used as the unique identifier for that recipient, then upon registration or sign-up, the recipient is required to enter his or her e-mail address. The present invention then compares this newly entered e-mail addresses with each stored e-mail address to determine if any items (e.g., codes, electronic addresses, electronic documents, etc.) have been stored in connection with this email address and, if so, the new user is granted access to all of these items by way of his or her new account.

A “Help” button 176 in FIG. 11 is also presented to allow user to obtain help regarding account usage. Help messages and/or tutorials are presented to a user upon selecting the “Help” button 176, which may conform to a variety of formatting options, as will be appreciated by those skilled in the art.

The account illustrated in the window 162 shown in FIG. 11 has a link 222 to a welcoming message in the form of an electronic document from the host server. When this link 222 is selected, the related electronic document is displayed directly in the window 162, corresponding to the document retrieval step 154 shown in FIG. 10. The check box 224 may be checked to select the electronic document, and the document may be deleted by way of the “Delete” link 226 or moved by way of the “Move” link 228. Additionally links could be provided for the user's convenience. For example, a “Send” link could be provided along with the “Delete” and “Move” links 226, 228. The manipulation of electronic documents in this manner corresponds to the organization step 156, shown in FIG. 10.

Properties of the message represented by the link 222 may be obtained by clicking on the “Prop” link 232. If notes have been appended to the electronic address 222, a “Note” button or link may be provided next to the “Prop” link 232, which, when selected by a user, would display any saved notes corresponding to the electronic document represented by the link 222. Notes displayed in this manner may be presented in a form editable by the user.

As can be seen in FIG. 11, various keywords associated with the electronic document (i.e., the message represented by the link 222) are shown, as well as the source (i.e., the type of source document referenced) 234 and date generated 236. A data entry field 237 is provided whereby a user may enter a code 20 for retrieval of an electronic document 22 corresponding to a physical document 18 from which the code 20 was acquired. A data entry field 238 is presented for a user to search each of the documents referenced in the user account upon entering information therein and clicking on the search button 240. It is anticipated that the search data entry field 238 and button 240 could also be used to search documents referenced in other users' accounts or within the entire system. A user, searching documents within the system, but not within the user account, could be presented with the option of adding any documents found via such a search to the user account. Additional buttons 242, 244, 246, 248 are provided to organize the user's contacts, manage the user's account, download documents for Web pages, and log-out, respectively.

In accordance with an embodiment of the present invention, a “type” column may be provided in the user account window 162. This type column may be used to display the name and/or logo of the advertiser or publisher associated with each electronic address. The name and/or logo may be presented as an electronic link, which, when selected by a user, will display the network location (e.g., WWW home page) of the publisher or advertiser. Alternatively, a logo based upon the electronic document itself could be displayed in a type column.

In the user account window 162, users may be able to change of the personal information, such as information provided during the sign-up process. Such updates may include, for example, adding multiple e-mail addresses, updating personal information, and changing passwords. When the user adds a new e-mail address, an e-mail message will be sent to that e-mail address indicating that the address had been registered with the system and may provide support contact information, or links to such information, in the case of problems or an error.

Additionally, the present invention could be used to develop personal codes for individual users and/or that user's personal files. For example, a unique, personalized code could be assigned to each user. This code could be, for example, embodied in an image (e.g., a TIFF file, EPS file, etc.). This image could then be printed on a business card, or other physical medium, whereby a user could share it with other users. This image could also be managed within a user account window 162, uniquely identifying the user in the same manner as a PIN. When a user of the system scans another user's code, that user's information could be automatically added to an address book, or other similar contact organizational tool.

Personal file codes could also be utilized in the user account window 162, and attached to a user's personal electronic files. Thus, a user could download codes to attach to their personal files that have been uploaded to the server. This could be accomplished, for example, by allowing a user to select a file and assign a code to it. The code could then be downloaded from the server and pasted into the actual file. Other users, when viewing the physical version of the user's personal document having the code pasted within, could access the electronic version of the physical document by way of the system and method of the present invention. This could be useful, for example, for such documents as personally distributed technical papers, brochures, trade show documents, and the like.

It is anticipated that additional information could be managed in the user account displayed in the window 162, shown in FIG. 11. For example, information regarding personal entertainment media collections could be organized by and stored within the database of the present invention. Thus, the functionality of the present invention could aid users in organizing things other than electronic documents (e.g., music CDs, DVDs, video cassettes, MP3s, photographs, recipes, etc.). Any information managed by the present invention could be tracked and organized according to media type and genre. Various user prompts could be provided to prompt a user for specific information regarding any new information to be saved. For example, upon cataloging a new music CD, a user could be prompted for such information as title, artist, genre, and the like. Rather than manually entering the information, this information could be extracted from a code on the product itself, which could be, for example, a code generated by the present invention as described herein, a universal product code (UPC), or other suitable code. An electronic version of the CD could also be maintained in a conveniently stored electronic file format.

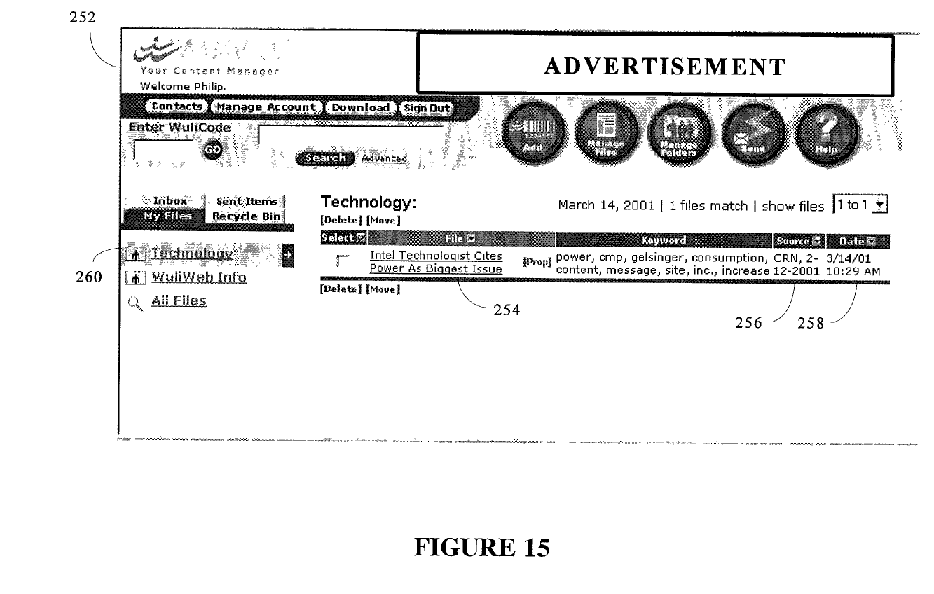

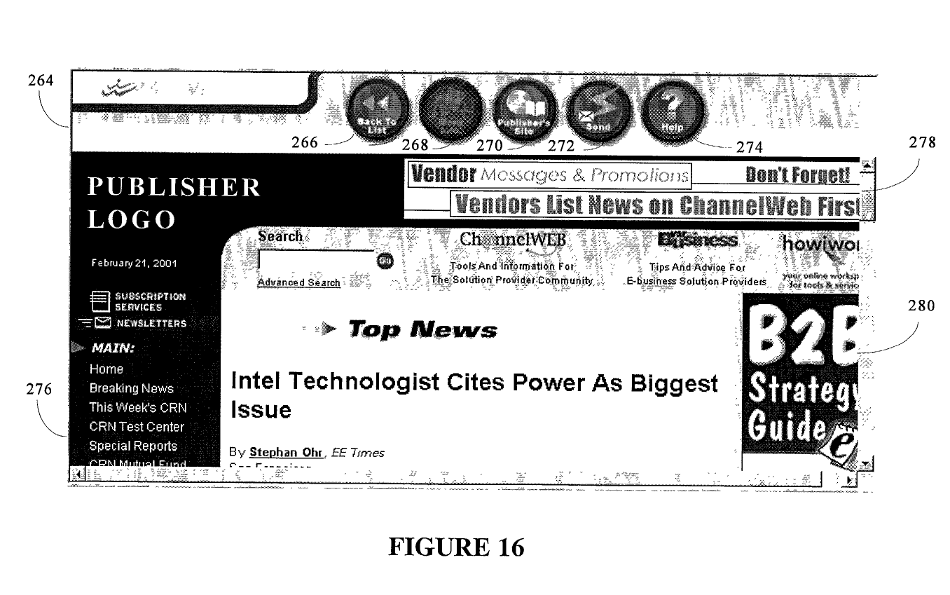

In FIG. 15, a computer screen image 250 is shown wherein a browser window 252 is illustrated displaying the user's files upon the addition of a new link 254, to an electronic document which corresponds to the code shown in field 54 of FIG. 4 and title shown in field 78 of FIG. 5. The source 256 and date retrieved 258 are also shown. It should be noted that this document's electronic address 254 is stored in the “Technology” folder 260, created by the user using the window 106, shown in FIG. 6. Upon selecting the link 254, which is the electronic address, or URL, of an electronic article, a user is presented with the window 264 illustrated in the computer screen image 262 of FIG. 16.

In FIG. 16, the document is displayed in electronic format, along with various advertisements and other links. Buttons 266, 268, 270, 272, 274 are provided for the convenience of the user according to meta data associated with the electronic document being displayed. Thus, these buttons may be replaced by other, more relevant, buttons, or the functionality provided by each button may be varied according to the meta data of the electronic document displayed.

For example, button 266 allows a user to return to the screen 250 illustrated in FIG. 15. In some instances, the button 268, which is disabled in FIG. 16 because of the lack of supporting meta data, allows a user to obtain more information regarding the content of a displayed electronic document. For example, this button could provide a link to subscription information according to meta data provided by the publisher. Button 270 allows a user to navigate to the Web site of the publisher of the electronic document. Button 272 allows a user to send the link to the electronic version of the document to other recipients, by way of a send window 202 shown in FIG. 14, and the help button 274 allows a user to obtain help regarding the screen displayed in the window 264.

As previously discussed, advertisements displayed in the window 264 may be directed to a particular user according to that user's usage characteristics, or other metrics. Additionally, the advertisements may be tailored according to the electronic document being displayed. For example, advertisers may utilize the keywords provided by publishers as meta data to determine which on-line publications would be most likely to reach a particular advertising target audience.

The window 264 displaying the electronic document contains links 276 to portions of the publisher's Web site and links to advertising 278, 280. It will be understood by those skilled in the art that such links could be determined by way of keywords and other meta information associated with the electronic document being displayed, or according to user metrics stored in a user profile, and intended audience information, for example.

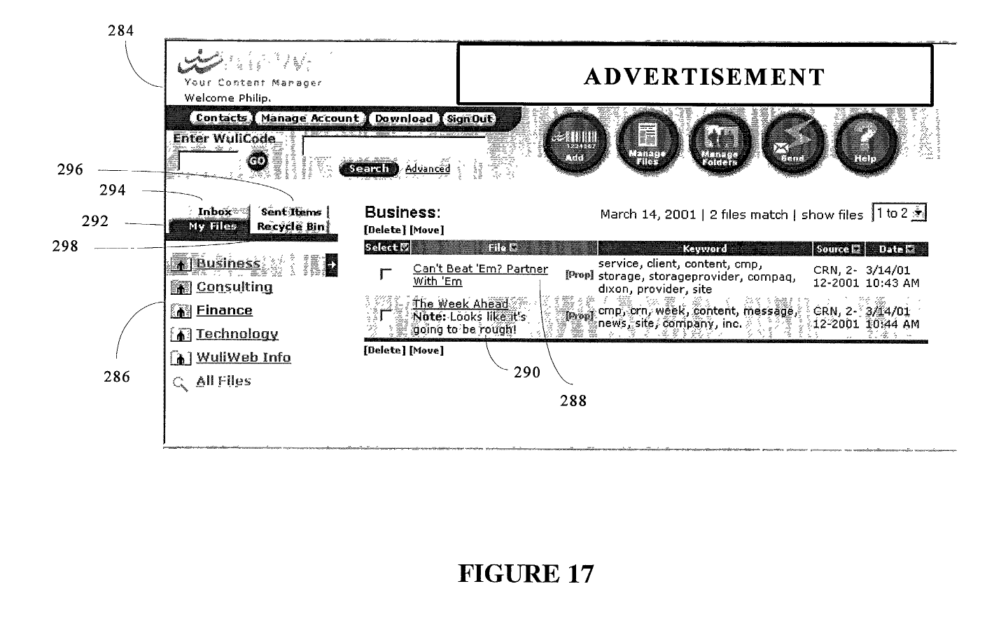

In FIG. 17, a computer screen image 282 is illustrated, wherein the same user account which is shown in FIG. 15 is shown; however, multiple folders 286 each containing electronic addresses of documents have been added. The “Business” folder shown has been selected, and contains links 288-290 to two documents that are displayed. For organization purposes, a user may add multiple folders 286 to organize each electronic link to electronic documents, and may store, view, search, and otherwise manipulate multiple electronic documents within these folders.

The user may view different portions of the user account by selecting one of the links presented as tabs 292, 294, 296, 298 that represent specific areas of the user account. The view shown is the “My Files” section; However, the user can select a view of the “In Box”, “Sent Items”, or the “Recycle Bin” by selecting their corresponding tab links. Documents or links to documents sent to the user are stored in the user's In Box. A user can delete files and/or links by placing them in the Recycle Bin which the user can later empty to permanently delete items stored therein.

When the user starts to get close to the user's disk space quota, (e.g. within about 90-95% of capacity) warning messages will be propagated and e-mail messages will be sent to remind him to empty his Recycle Bin. These messages and warning e-mail messages will display how much space the Recycle Bin and My Files sections of the user account occupy. Files can also be restored from the Recycle Bin, in which case, the system can automatically indicate a restoration by, for example, appending “(restored)” to the end of the file name.

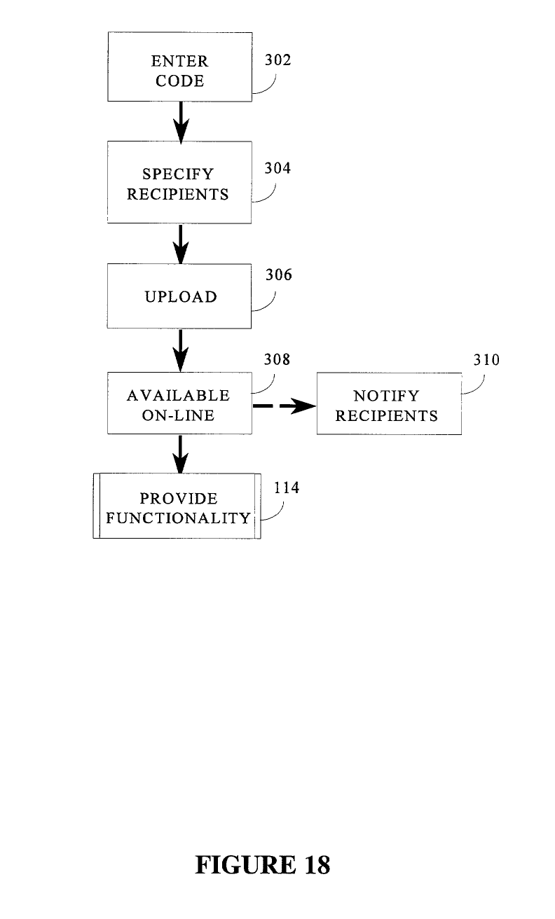

In FIG. 18, a flow diagram of the device input process 300 is illustrated. The device input process 300, in accordance with an embodiment of the present invention allows, for a document code to be obtained by way of a variety of devices and transferred to the client computer 12, as shown in steps 44 and 46 of FIG. 3. First, the code relating to the desired electronic document is entered in step 302. This includes either scanning, or otherwise electronically reading the code, or manually entering a code, which is contained on the physical document and relates to the electronic document of interest.

In step 304, in accordance with an embodiment of the present invention, various recipients may be specified for receipt of electronic links, or electronic addresses of electronic documents that correspond to the document code entered in step 302. Recipients may be specified by any unique identifier. Some examples include an e-mail address, a name, and telephone number. Additional recipient identifiers could also be used, as will be appreciated by those skilled in the art. Upon specifying desired recipients in step 304, the client computer 12, shown in FIG. 1, uploads, or otherwise transfers, the document code information to the server 14, also shown in FIG. 1, in step 306.

In step 308, the server provides on-line an electronic address or link, to the electronic version of the physical document corresponding to the code entered in step 302. This on-line availability is provided not only for the user who provided the document code, but for all of the recipients specified in step 304 as well. In the case of recipients being specified in step 304, a notification message may also be sent via e-mail to those recipients in step 310, as indicated by the broken line in FIG. 18. As previously discussed in connection with FIG. 7 (step 122), notification messages sent via e-mail can be configured to contain customized information from a publisher, such as subscription enabling information and the like. Each user, upon logging in to review the on-line version of the document for which the code was entered in step 302, will be provided with the functionality shown in subroutine 114, which is the same functionality described in connection with FIGS. 3 and 7.

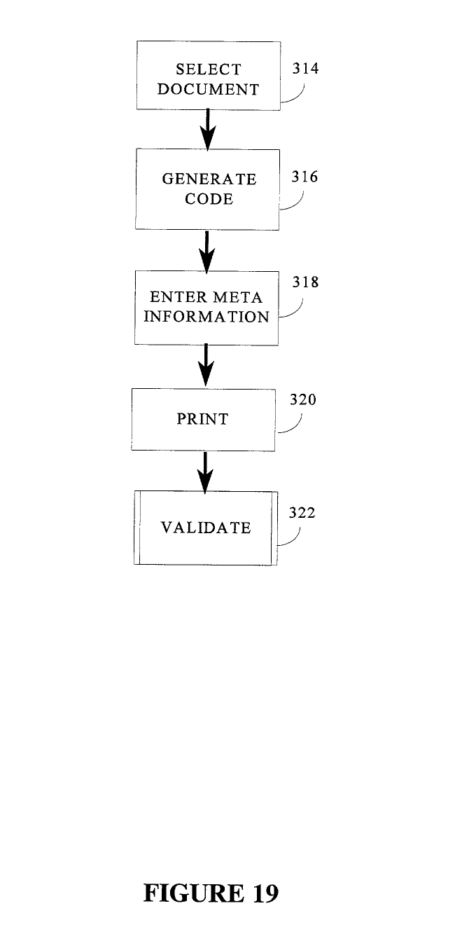

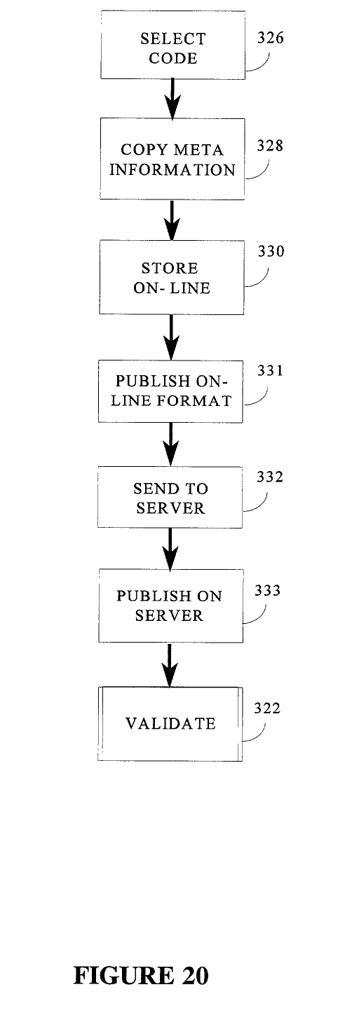

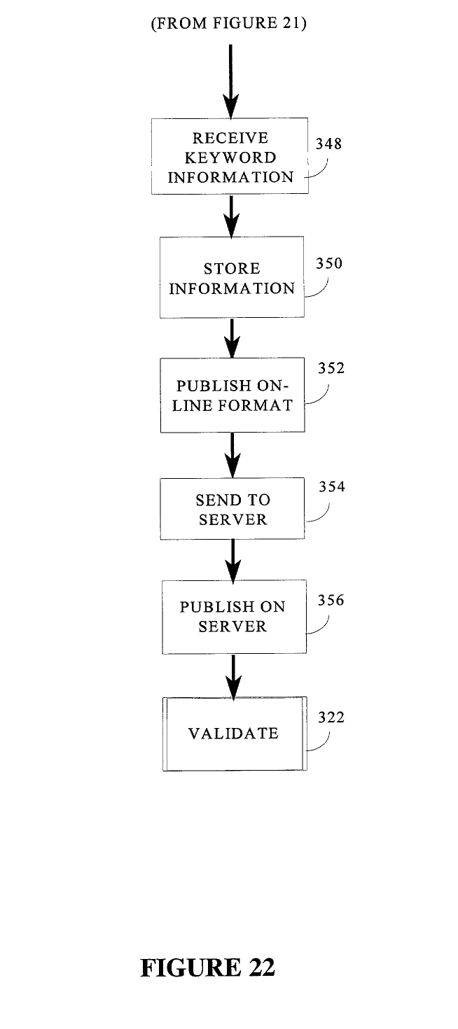

In connection with FIGS. 19-23, aspects related to publishing the documents used by the present invention are discussed. It will be recognized by those skilled in the art that the present invention makes use of various types of documents and publishing, all of which are discussed in connection with the present invention. For example, the present invention makes use of physical publishing techniques to create physical, printed documents, and electronic publishing to create electronic documents in an electronic format. Additionally, a publishing technique is used, which comprises essentially cataloging the electronically published version of the document into the document management system that resides on the server 14. This third publishing technique is referred to in steps 333 and 356 of FIGS. 20 and 22, respectively.

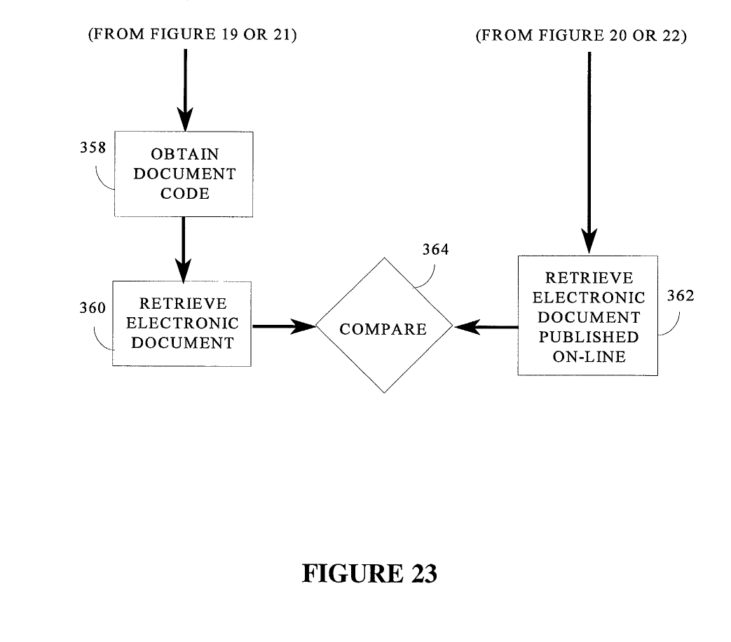

In FIG. 19, the print layout process 312 associated with an embodiment of the present invention is illustrated. This is the process whereby publishers of physical, printed documents present documents with integrated codes that may be used by the system and/or method of the present invention. Specifically, a printed document is selected at step 314, and a code associated with that document is generated at step 316. Keyword and other meta information is entered by the publisher in step 318, which may comprise a variety of technical terms and/or other information such as subject matter, expected audience, URLs to related documents, URLs to more information, potential advertising topics, and the like, and which can be incorporated in the electronic document as meta data. At this point, the document is ready for printing and is printed in step 320 represented by broken lines. Once the document is printed, a validation subroutine 322 uses the printed document code to verify that the correct electronic document is retrieved using the printed code. This validation subroutine is shown in detail in FIG. 23.

The on-line publishing process 324, which may proceed in parallel with the print layout process 312 is illustrated in FIG. 20. It is by this process that electronic documents presented from publishers are prepared and published on-line at a host website. In FIG. 20, a code is selected 326 for a desired electronic document and keyword information and other meta information associated with that electronic document is copied 328. This information is stored and copied to an on-line repository, such as a web server for HTML publishing, in step 330. The information copied from publishing software to a web server for publishing in step 330 is copied in this manner because of limitations associated with current publishing software packages. However, as will be recognized by those skilled in the art, this step may be rendered unnecessary by future publishing software packages including web publishing capabilities, and such changes are intended to be fully embraced within the present invention. The document may then be published in an on-line or electronic format, as shown at step 331. Once the document has been published in an on-line format, it is sent to the server 332, and published on the server 333. After the document is published on the server at step 333, validation occurs by way of the validation subroutine 322.

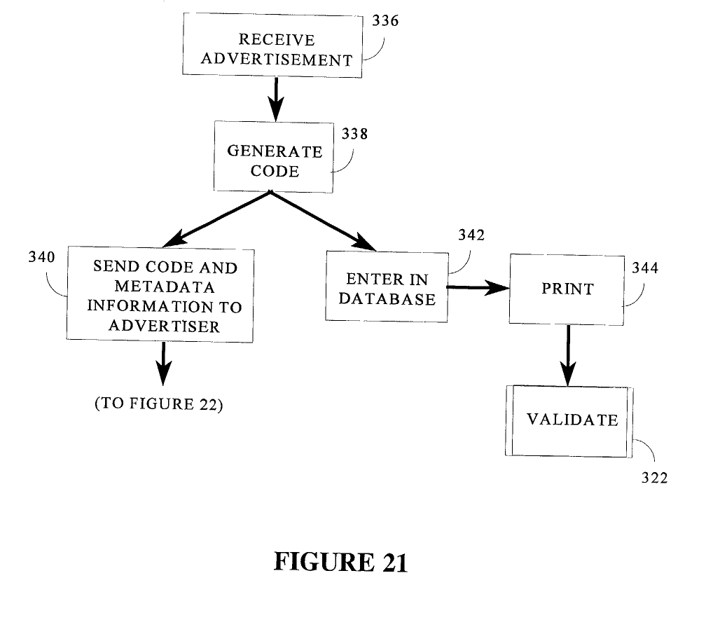

In FIG. 21, the publisher advertisement layout process 334 is shown in the form of a flow diagram. This is the process whereby advertisements may be printed and/or displayed on-line in accordance with an embodiment of the present invention. This process 334 may be combined with the processes illustrated in FIGS. 19 and 20, to correlate advertisements to be displayed with particular electronic documents, in a form of directed advertising. By way of the present invention, the publisher generates and places a code in the physical document, while advantageously the advertiser controls the electronic document that the code refers to. Thus, the advertiser can obtain usage statistics and other useful information regarding the electronic document. However, those skilled in the art will appreciate that various relationships between publishers and advertisers could be used within the present invention, and such changes are intended to be embraced herein.

In accordance with one embodiment of the present invention, meta information may be supplied by a party other than the publisher. For example, an advertiser may supply such meta information and may update the code, or information related to the code in the database. A publisher that selects a unique code may, for example, grant access to an advertiser, or other third party, to update the code, or any information relating thereto in a central database. Thus, while the publisher has the ability generate or select a code, and places the code in the document, the advertiser subsequently may be granted access to further manipulate the code or the document to which the code relates. This may occur as the publisher sends the code to the advertiser, and the advertiser updates URL and meta information corresponding to the code. Likewise, the publisher might also grant permission to other third party entities to manipulate and update either the code or the information relating to the code in the database.

In FIG. 21, an advertisement is received 336 and a code is generated at step 338. Once the code associated with the advertisement is generated, code information (along with other meta information) is transmitted to the advertiser 340, and the advertiser process that handles this keyword information is shown in FIG. 22 and described in connection therewith. Upon generation of the code related to the advertisement in step 338, the information is entered into an advertisement database 342. After the information has been entered into the database, the advertisement is then printed in step 344, and once the advertisement is printed, the validation subroutine 322, described in connection with FIG. 23, is carried out.

When keyword information is sent in step 34 of the advertisement layout process 334 shown in FIG. 21, the advertiser on-line publishing process 346, shown in FIG. 22 handles this information. First, it receives the keyword information 348 and stores this information in an advertisement repository 350, while maintaining information regarding the electronic document referred to by the code. The information is then published in an on-line format in step 352, and sent to the server 354. As with the on-line storage step 330 of FIG. 20, the on-line storage step 350 is used as a result of capability not included in publishing software packages. The server then publishes the web format in step 356, and validation occurs 322 as described in connection with FIG. 23. Should this feature become available in publishing software packages in the future, the present invention may utilize such an improvement by removing this step from the advertisement layout process.

The validation subroutine 322 is illustrated in FIG. 23. By way of this validation subroutine, the document code associated with the physical printed document is obtained either from the print layout process 312 of FIG. 19, or the publisher advertisement layout process 334 shown in FIG. 21, in step 358. Once this document code is obtained, the electronic document is retrieved in step 360. The electronic document published on-line is obtained in step 362 from either the on-line publishing process 324 shown in FIG. 20, or the advertiser on-line publishing process 346 shown in FIG. 22. Once both of these electronic documents have been retrieved, both by way of the physical document code, as with step 360, and by way of the on-line publishing process, as with step 362, the two electronic versions are compared in step 364. If the two versions are found to be identical, then the on-line publishing proceeds. If, however, there found to be different, then the documents are reacquired, or a new code is generated for the physical document corresponding to the correct physical document. This validation subroutine 322 may be accomplished either normally or automatically, by way of software, for example.

From the foregoing, it can be seen that the present invention provides a system and method for linking real world objects to digital objects, or physical, printed publications with electronic versions of those printed publications. The preferred embodiment of the present invention is directed to a system and method that utilizes a code contained on the printed publication, which allows a user to retrieve via the a network an electronic address of an electronic version of the printed document from a server using client software on a client computer.

It will be appreciated by those of ordinary skill in the art that the present invention can be embodied in other specific forms without departing from the spirit or central characteristics thereof. For example, the invention has been described in the context of scanning document identification code information, or manually entering such information into a client computer, which then transmits the information to a remotely located server. The client computer is described as having client software that retains information specific to a particular user. However, this information can be maintained at different locations on a computer network, and client software may be maintained at a network gateway, or a remotely located server, in a distributed computing environment. Additionally, the codes associated with each of the desired publications need not be entered into a computer at all, but may be accessed by any manner that provides the needed information to the remotely located server.

The presently disclosed embodiments are therefore considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A document management system for transmitting a code contained in a physical document from a client computer to a server to retrieve an electronic version of the physical document from the server, comprising:
client software residing on the client computer operative to receive and transmit a code relating to a physical document to a server connected to a client computer by way of a network;
a database accessible by the server for retrieving an electronic address of the electronic version of the physical document by relating the code to the electronic address; and
server software residing on the server operable to receive the code transmitted by the client software via the network and retrieve from the database an electronic address of the electronic version of the physical documents related to the code.

2. The system of claim 1, wherein the electronic version of the physical document is stored in a network location accessible to the server and is managed by the client software.

3. The system of claim 1, wherein the client software is further configured to retrieve an electronic version of the physical document from the electronic address provided by the server software.

4. The system of claim 1, wherein the code is a barcode.

5. The system of claim 1, wherein the code is a legible numeric code.

6. The system of claim 1, wherein said network comprises one of a LAN, a WAN, a VPN, a wireless network, or the Internet

7. The system of claim 1, further comprising a device for acquiring the code.

8. The system of claim 7, wherein the device comprises a data input device.

9. The system of claim 8, wherein the data input device comprises a personal digital assistant (PDA).

10. The system of claim 8, wherein the data input device comprises a scanner.

11. The system of claim 10, wherein the scanner comprises a barcode scanner.

12. The system of claim 10, wherein the data input device comprises a keyfob.

13. The system of claim 8, wherein the data input device comprises a telephone.

14. The system of claim 7, wherein the code received by the client software residing on the client computer is received from the device for acquiring the code.

15. The system of claim 1, wherein the database resides on the server.

16. The system of claim 1, wherein the client software resides on a network gateway computer.

17. The system of claim 1, wherein the client software resides on the server.

18. The system of claim 1, wherein the server software is further configured to process electronic documents on the basis of keywords and meta information.

19. The system of claim 1, wherein the server software is configured to track metrics of users.

20. The system of claim 19, wherein the server software is configured to update user profiles according to the user metrics.

21. The system of claim 2, wherein a user may view, share, and send the electronic version of the physical document.

22. A method of managing electronic versions of physical documents comprising the steps of:
mapping a code to an electronic address of an electronic version of a physical document;
acquiring a code relating to a physical document;
finding the electronic address of an electronic version of the physical document relating to the code;
transmitting the electronic address to a user;
maintaining the electronic version of the physical document; and
using the code as a proxy to the electronic version of the physical document.

23. The method of claim 22, further comprising the step of transferring the obtained document code to a client computer.

24. The method of claim 23, further comprising the step of processing the acquired code using software on a client computer.

25. The method of claim 22, further comprising a step of transmitting the obtained code related to physical document to a server, which performs the step of finding.

26. The method of claim 25, wherein the server performs the step of finding by way of an electronic database relating codes associated with physical documents to electronic addresses of electronic versions of the physical documents.

27. The method of claim 22, further comprising the steps of:
indicating recipients to receive copies of the electronic address associated with the electronic version of the physical document associated with a code; and
transmitting the electronic address to each designated recipient.

28. The method of claim 27, further comprising the step of transmitting a message to each recipient regarding the transmitted electronic address.

29. The method of claim 22, wherein the electronic address comprises a URL.

30. The method of claim 22, wherein the electronic address transmitted to a user is stored in a user account.

31. The method of claim 30, wherein the user account allows for customized organization of each electronic address stored in the user account.

32. A method for creating an electronic document from a physical document for later review by a user by way of an electronic address related to the electronic document, comprising the steps of:
generating markup language that represents the physical document;
creating an electronic document that is an electronic version of the physical document from the markup language;
generating markup language annotation information regarding the contents of the physical document to be placed in the electronic document;
generating an electronic address related to a network location of the electronic document; and
publishing the electronic document to the network location.

33. The method of claim 32, wherein the electronic address of each document is maintained in a database accessible by a server.

34. The method of claim 32, wherein the database relates each electronic address to a code located on each physical document associated with the electronic document represented by the document electronic address.

35. The method of claim 32, wherein the markup language annotation information comprises meta data regarding the physical document.

36. The method of claim 35, wherein the meta data is stored in extensible markup language (XML) fragments within the electronic document.

37. The method of claim 32, wherein the electronic address comprises a URL.

38. The method of claim 32, further comprising the steps of:
reading the electronic document;
searching the electronic document for annotation information contained therein; and
determining from the annotation information, details of the electronic document.

39. The method of claim 38, wherein the annotation information comprises meta data.

40. The method of claim 39, wherein the annotation information is encoded using extensible markup language (XML).

41. The method of claim 38, wherein the electronic document comprises a markup language encoded version of the physical document.

42. The method of claim 41, wherein the markup language encoded version of the physical document comprises an HTML-encoded document.

43. The method of claim 38, further comprising the steps of:
receiving a code from a physical document; and
comparing the details of the code contained in the annotation information of the electronic document with the code received from the physical document.

44. The method of claim 43, further comprising the step of:
validating the code received from the physical document, if, during the step of comparing, it is determined that the code contained in the annotation information of the electronic document and the code received from the physical document are the same.

45. The method of claim 38, wherein the electronic document is received from a publisher.

46. A method for creating, upon a physical document, a unique code corresponding to information contained in an electronic version of the physical document, comprising the steps of:
acquiring a unique code corresponding to information contained in an electronic version of a physical document presented as an electronic document;
printing the code on the physical document;
generating annotation information regarding the contents of the physical document to be placed in the electronic document; and
maintaining a correspondence between the code and information contained in the electronic document by storing the annotation information within the electronic document.

47. The method of claim 46, wherein the annotation information comprises meta information.

48. The method of claim 47, wherein the annotation information is contained in markup language fragments within the document.

49. The method of claim 48, wherein the markup language fragments comprise XML fragments.

50. A method of electronically publishing an index to a publication while preserving the structure of the physical document and providing links to a plurality of electronic documents, comprising the steps of:
receiving an electronic index corresponding to the plurality of electronic documents;
parsing the electronic index;
locating in the electronic index, a plurality of electronic addresses corresponding to the electronic documents; and
using the electronic index to identify a larger unit of publication relating to many smaller units of publication.

51. The method of claim 50, wherein the plurality of electronic addresses is stored in a database.

52. The method of claim 51, wherein the plurality of addresses stored in the database are related to corresponding physical documents using a mapping function.

53. The method of claim 52, wherein the mapping function relates a code contained in the physical document with the electronic address of the corresponding electronic document.

54. The method of claim 50, wherein the plurality of electronic addresses are stored together in an electronic index format.

55. The method of claim 54, wherein the electronic index format comprises a hypertext markup language (HTML) format.

56. A method of associating meta information with an electronic document within a document management system, comprising the steps of:
analyzing the electronic document;
determining keywords associated with the electronic document;
storing the keywords as meta information in an electronic form;
storing the keywords as meta information within the document management system; and
tailoring presentation of the electronic document to a user according to stored meta information relating to the electronic document.

57. The method of claim 56, wherein the keywords are stored in a database.

58. The method of claim 56, wherein the meta information is stored as markup language fragments within the electronic document.

59. The method of claim 58, wherein the markup language fragments comprise extensible markup language (XML) fragments.

60. The method of claim 56, wherein the electronic document is formatted in a hypertext markup language (HTML) format.

61. The method of claim 56, wherein the electronic document is formatted as a text document.

62. The method of claim 56, wherein the stored meta information is supplied by a third party.

63. The method of claim 62, wherein the stored meta information is supplied by a publisher.

64. An electronic document sharing system, comprising:
a physical document containing a unique code relating the physical document to a corresponding electronic document;
means for reading the unique code from the physical document;
means for retrieving the electronic document related to the physical document;
means for manipulating the electronic document; and
means for tracking usage associated with manipulating the electronic document.

65. The system of claim 64, wherein the means for manipulating the electronic document comprises a means for electronically sending the code associated with the electronic document to a plurality of users.

66. The system of claim 65, wherein said means for electronically sending comprises a means for sending an e-mail message.

67. The system of claim 66, wherein the means for tracking usage comprises tracking one of a user's communication, file transferring, file sharing, or link following.

68. The system of claim 66, wherein the means for tracking usage tracks e-mail addresses of the plurality of users.

69. The system of claim 68, wherein the means for electronically sending an e-mail message comprises a means for sending a follow-up e-mail message to the plurality of users regarding the code sent to the plurality of users.

70. The system of claim 69, wherein user statistics are maintained by the means for tracking usage for each of the plurality of users according to the email addresses of the plurality of users.

71. The system of claim 70, wherein the user statistics are stored in a user profile.

72. The system of claim 71, further comprising:
means for analyzing statistics stored in the user profile.

73. A method for relating a physical document to an electronic version of the document via a code printed on the physical document, comprising the steps of:
selecting a unique code for a physical document;
relating the unique code to an electronic version of the physical document; and
updating the code;
wherein a first entity performs the following steps:
selects the unique code;
prints the physical document;
sends the code to a second entity; and
authorizes the second entity to update information regarding the code; and
wherein the second entity receives the code from the first entity and updates a database entry regarding the code.

74. The method of claim 73, wherein the second entity updates the database by updating meta information in the database corresponding to the code.

75. The method of claim 73, wherein the second entity updates the database by updating uniform resource locator (URL) information in the database corresponding to the code.

76. An electronic document sharing system, comprising:
means for sending electronic links to documents to one or more users;
means for identifying the one or more users receiving the electronic links by a unique identifier; and
means for the one or more users to retrieve the documents in electronic format via the electronic links.

77. The system of claim 76, wherein the unique identifier is an e-mail address.

78. The system of claim 76, further comprising:
means for storing the electronic links sent to each recipient according to recipient;
means for determining if each recipient has a system account; and
means for providing each recipient having a system account with access to the electronic links sent to each recipient by way of each recipient's respective system account.

79. The system of claim 78, further comprising:
means for determining that a new user, upon registration for a system account, has previously been a recipient of one or more electronic links, and for providing the new user with access to the one or more electronic links.

80. A method for transmitting electronic codes relating to electronic documents between computer users, comprising the steps of:
A first computer user sending an electronic code to one or more recipients;
identifying the recipients by way of a unique identifier;
storing each recipient's unique identifier; and
storing each code sent to each of the one or more recipients according to the unique identifier of each corresponding recipient.

81. The method of claim 80, wherein the unique identifier is an e-mail address.

82. The method of claim 80, wherein the electronic code is represented by a uniform resource locator (URL).

83. The method of claim 80, further comprising the steps of:
determining if the recipients have an account by way of the unique identifier of each recipient; and
providing each recipient that has an account with access to the code sent by way of each recipient's individual account.

84. The method of claim 80, further comprising the steps of:
registering a new user;
determining whether or not the new user has previously been a recipient of an electronic code by comparing the new user's unique identifier with the stored recipient identifiers; and
if the new user has previously been a recipient, making the code previously sent to the new user available by way of an account provided to the new user upon registration.
